(19) United States
(12) Patent Application Publication
(10) Pub. No.: US 2026/0085010 A1
(43) Pub. Date: Mar. 26, 2026

(54) CEMENTITIOUS COMPOSITIONS AND RELATED METHODS

(71) Applicants: Boral Resources (WA) Limited, North Ryde, New South Wales (AU); Boral Construction Materials Limited, North Ryde, New South Wales (AU); Boral Limited, Sydney, New South Wales (AU)

(72) Inventors: Bogdan H. DANA, North Ryde, New South Wales (AU); David HOCKING, North Ryde, New South Wales (AU); Louise M. KEYTE, North Ryde, New South Wales (AU)

(73) Assignees: Boral Resources (WA) Limited, North Ryde, New South Wales (AU); Boral Construction Materials Limited, North Ryde, New South Wales (AU); Boral Limited, Sydney, New South Wales (AU)

(21) Appl. No.: 19/103,786

(22) PCT Filed: Aug. 16, 2023
(86) PCT No.: PCT/AU2023/050773

§ 371 Date: Feb. 13, 2025

Related U.S. Application Data
(60) Provisional application No. 63/398,403, filed on Aug. 16, 2022.

(51) Int. Cl. C04B 28/08; C04B 28/02; C04B 28/04; C04B 40/00; C04B 103/00; C04B 103/10; C04B 103/40; C04B 111/34

(52) U.S. Cl. CPC C04B 28/08; C04B 28/021; C04B 28/04; C04B 40/0039; C04B 2103/0079; C04B 2103/10; C04B 2103/408; C04B 2111/34

(57) ABSTRACT

Compositions of alkali activators useful in cement mixtures and concrete are described. The composition may include anhydrous sodium sulfate, a dispersant, a humectant, at least one additive, and water. Exemplary additives include rheology modifiers, de-foamers, biocide agents, surface tension agents (as synthetic additives or additives derived from naturally occurring sources), and combinations thereof. The composition may include about 20% by weight to about 80% by weight solids, based on the total weight of the composition, for example. Cement mixtures and concrete compositions are also described, as well as methods of preparing such compositions, cement mixtures, and concrete compositions.

### TECHNICAL FIELD

The present disclosure generally relates to additives useful in manufacturing of cementitious materials, and methods of preparation and use of such cementitious materials.

### BACKGROUND

Waste by-products have found new use as fillers in building materials. Ground granulated blast-furnace slag (GGBFS), a by-product from pig iron production, and fly ash from coal combustion typically have hydraulic or pozzolanic properties of interest as supplementary cementitious materials (SCMs) for the manufacture of concrete. Other industrial and waste or raw products from the mining and agricultural industry have been tested or even employed lately as supplementary cementitious materials, such as but not only limited to: Silica Fume (SF), Fly Ash (FA), various types of aluminium silicates, Incinerator Bottom Ash (IBA), Rice Husk Ash (RHA), Metakaolin (MK), Coconut Husk Ash (CHA), Palm Oil Fuel Ash (POFA), Wood Waste Ash (WWA), Sugar Cane Ash (SCA), Corn Cob Ash (CCA), and Bamboo Leaf Ash (BLA). However, the chemical composition of SCMs present complications due to their impact on setting time and strength properties of concrete. Many activators are viscous, corrosive, and expensive, thus endangering those involved in mixing of cementitious mixtures and manufacturing concrete.

### SUMMARY

The present disclosure includes compositions useful as activators in cement mixtures and concrete and methods of use thereof. For example, the present disclosure includes a composition comprising sodium sulfate, e.g., anhydrous sodium sulfate; a dispersant; a humectant; at least one additive chosen from a rheology modifier, a de-foamer, a biocide agent, a surface tension agent, a surface tension agent, a biopolymer, or a combination thereof; and water; wherein the composition comprises about 20% by weight to about 80% by weight solids, based on the total weight of the composition. The composition may be in the form of a slurry, a dispersion, a suspension, or an emulsion. For example, the composition may comprise from about 20% by weight to about 75% by weight of the sodium sulfate, e.g., anhydrous sodium sulfate, based on the total weight of the composition. The anhydrous sodium sulfate can be used on its own or blended in different proportions with different types of biopolymers. In some examples, the composition may comprise from about 1% by weight to about 20% by weight of the dispersant based on the total weight of the composition. According to some aspects, the dispersant comprises a polymer, copolymer, or ionic compound; optionally wherein the polymer or copolymer comprises at least one functional group chosen from carboxyl, sulfate, phosphate, amine, ammonium, and/or silane; optionally wherein the dispersant comprises an acrylic polymer, an acrylic copolymer, a styrene polymer, a styrene copolymer, a vinyl polymer, or a vinyl copolymer.

In at least one example, the composition comprises from about 10% by weight to about 40% by weight of the humectant based on the total weight of the composition. The humectant may comprise, for example, an alcohol, optionally a polyol such as glycerol. Additionally or alternatively, the composition may comprise from about 0.1% by weight to about 0.5% by weight of a biocide agent based on the total weight of the composition. The biocide agent may comprise, for example, an isothiazolinone, optionally benzisothiazolinone and/or methyl-4-isothiazolin-3-one. Further, in some examples, the composition comprises from about 0.1% by weight to about 0.5% by weight of a de-foamer based on the total weight of the composition. The de-foamer may comprise, for example, silicone such as a silicone compound or polymer, a surfactant capable of promoting foam burst, or a hyper-branched polymer. In some examples, the composition comprises from about 0.1% by weight to about 3.0% by weight of a rheology modifier based on the total weight of the composition. According to some aspects herein, the rheology modifier comprises a thixotropic agent or a thickener, optionally wherein the rheology agent comprises a clay such as an organo-clay or synthetic clay, a hydrogenated castor wax, a polyamide, a silica such as fumed silica or colloidal silica, a cellulosic material, or a hydrophobically-modified material such as a hydrophobically modified ethoxylated urethane, a hydrophobically-modified alkali-swellable emulsion, a hydrophobically-modified hydroxy ethyl cellulose), or a hydrophobically modified ethoxylated urethane alkali swellable emulsion.

In some aspects, the composition has a Brookfield viscosity at 25° C. within a range of about 1000 cP to about 3500 cP and/or a pH equal to or greater than 8.0. The composition may be stable; for example, the composition may be stable for at least one week (a one week period) at a temperature between 2° C. and 45° C. In some examples, stability may be evident wherein the viscosity of the composition at 25° C. varies less than 10% during the at least one week period. The composition may be a homogeneous mixture.

The present disclosure also includes methods of making the compositions described above and elsewhere herein. In some examples, the method of making the composition comprises combining the sodium sulfate, e.g., anhydrous sodium sulfate, with the dispersant, the humectant, and the at least one additive to form a mixture, optionally wherein the mixture comprises a homogeneous paste; and combining the mixture with the water and optionally one or more other additives. According to some aspects, combining the sodium sulfate, e.g., anhydrous sodium sulfate, with the dispersant, the humectant, and the at least one additive includes preparing a blend of the humectant, the dispersant, and the at least one additive, and then combining the blend with the anhydrous sodium sulfate. The method may comprise, for example, preparing a blend by combining the humectant, the dispersant, and a biocide agent; combining the blend with the anhydrous sodium sulfate to form a mixture; combining the mixture with the water to form a slurry; and adding a rheology modifier and/or one or more other additives to the slurry. In at least one example, the blend further comprises a de-foamer.

The present disclosure also includes cement mixtures comprising the compositions described above and elsewhere herein. An exemplary cement mixture comprises at least 50% by weight of a combination of the composition and a supplementary cementitious material; and less than 50% by weight cement, such as General Purpose cement. According to some aspects, the cement mixture further comprises a Shrinkage Limited cement. The cement mixture may comprise, e.g., as the supplementary cementitious material or in addition to the supplementary cementitious material, one or more cementitious materials chosen from slag, fly ash, silica fume, or a combination thereof. In at least one example, the cement mixture comprises 20% or less by weight of the General Purpose cement.

The present disclosure also includes concrete compositions prepared from the compositions described above and elsewhere herein. In some examples, the concrete composition comprises a cement mixture as described above and an aggregate. The aggregate may comprise, for example, a coarse aggregate such as granite, basalt, quartz, laterite, or limestone, and/or a fine aggregate such as sand. According to some aspects herein, the concrete may have an air content less than or equal to 7% by volume (e.g., measured according to standard AS1012.4.2). Additionally or alternatively, the concrete may have an initial setting time less than or equal to 4.5 hours, and/or a final setting time less than or equal to 6 hours (e.g., measured according to standard AS1012.18-1996). Further, for example, the concrete may have a compressive strength at 28 days greater than or equal to 20 MPa (e.g., measured according to standard AS1012.9).

The present disclosure also includes a composition comprising about 10% by weight to about 75% by weight anhydrous sodium sulfate based on the total weight of the composition; about 1% by weight to about 20% by weight of a dispersant based on the total weight of the composition; about 10% by weight to about 40% by weight of a humectant based on the total weight of the composition; at least one additive chosen from a rheology modifier, a de-foamer, a biocide agent, a surface tension agent, a biopolymer, or a combination thereof; and water; wherein the composition is in the form of a slurry, a dispersion, a suspension, or an emulsion.

The present disclosure also includes a method of making a cement mixture, the method comprising combining General Purpose GP cement and a supplementary cementitious material SCM with a composition comprising: anhydrous sodium sulfate; a dispersant; a humectant; at least one additive chosen from a rheology modifier, a de-foamer, a biocide agent, a surface tension agent, a biopolymer, or a combination thereof; and water; wherein the composition comprises about 10% by weight to about 80% by weight solids, based on the total weight of the composition, the composition being in the form of a slurry, a dispersion, a suspension, or an emulsion. In at least one example, the cement mixture comprises less than 50% by weight of the General Purpose cement, based on the total weight of the cement mixture.

### DETAILED DESCRIPTION

The singular forms “a,” “an,” and “the” include plural reference unless the context dictates otherwise. The terms “approximately” and “about” refer to being nearly the same as a referenced number or value. As used herein, the terms “approximately” and “about” generally should be understood to encompass ±5% of a specified amount or value. All ranges are understood to include endpoints, e.g., a weight ratio between 1.5 and 3.5 includes weight ratios of 1.5, 3.5, and all values between.

The present disclosure includes compositions useful in preparing cement mixtures and concrete. For example, the composition may act as an activator that helps to control setting time and promote early strength development, including using cement mixtures and concrete products that comprise supplementary cementitious materials. The compositions herein may be in the form of a slurry, a dispersion, a suspension, or an emulsion. For example, the composition may comprise water and from about 10% to about 80% by weight solids, based on the total weight of the composition, such as, e.g., from about 20% to about 80%, from about 30% to about 80%, from about 40% to about 80%, from about 50% to about 80%, from about 60% to about 80%, from about 70% to about 80%, from about 55% to about 75%, from about 35% to about 60%, from about 50% to about 70%, or from about 65% to about 75% by weight solids, based on the total weight of the composition. The composition may be formulated as an admixture useful during manufacturing of cement and/or concrete, e.g., as a chemical activator useful for improving the properties of binders used in cement and concrete manufacturing. The compositions herein may be relatively easy to handle, transport, and/or store over time, and may be useful in manufacturing environmentally friendly concrete.

The compositions herein comprise sodium sulfate (Na₂SO₄), e.g., anhydrous sodium sulfate. Anhydrous sodium sulfate is hygroscopic, meaning that it takes up and retains moisture. Humidity and temperature may impact its flowing properties. While the hygroscopic properties of sodium sulfate are generally associated with excessive clumping and difficult processing conditions, the compositions herein may avoid such problems. As discussed below, the compositions may be prepared as homogeneous mixtures (e.g., in the form of a slurry, a dispersion, a suspension, or an emulsion) with short-term and/or long-term stability. The sodium sulfate may contribute to the composition's ability to serve as a chemical activator, e.g., promoting dissolution of supplementary cementitious materials in cement mixtures used in the production of concrete. The sodium sulfate can be blended (0-100% proportions) with various types of biopolymers of high pH that can also activate and/or stabilise the SCMs chosen to replace GP cement in environmentally friendly concrete products. The compositions herein may be easier to handle, transport, and/or store prior to usage in cement mixtures as compared to hygroscopic, abrasive sodium sulfate powder.

Biopolymers for use in activating and/or stabilising SCMs in embodiments of the invention can come from agro-resources extraction and biotechnology through microorganism fermentation and conventional synthesis. Extraction of natural materials or agro-resources materials produce biopolymers useful for the purpose of creating alkali activators for mortar and concrete such as polysaccharides, cellulose, starch, chitin, chitosan, and alginates. For instance, biotechnology through microorganism fermentation can be used to produce polyhydroxyalkanoates (PHAs), and biotechnology using conventional synthesis could produce polylactides, and biopolyethylene (PE). Both sources give different dosage levels, product quality, price and environmental safety. Details of synthesis, modification and use of PHAs as engineering materials are described in “Polyhydroxyalkanoates: opening doors for a sustainable future” (Zibiao Li et al, NPG Asia Materials (2016) 8, e265; doi:10.1038/am.2016.48), the content of which is incorporated herein by reference. The biopolymers of choice for the purpose of embodiments of the present invention preferably have a pH above 9, and can be used in powder form, as liquids and/or as fibers

The compositions may comprise from about 20% to about 75% by weight of the activator (anhydrous sodium sulfate and/or biopolymer) based on the total weight of the composition, such as, for example, from about 20% to about 35% by weight, from about 30% to about 45% by weight, from about 40% to about 55% by weight, from about 50% to about 65% by weight, from about 60% to about 75% by weight, or from about 65% to about 75% by weight, based on the total weight of the composition.

The compositions herein may also comprise one or more dispersants, which may inhibit and/or prevent re-association of solid/powder sodium sulfate particles. The dispersant(s) may be ionic or non-ionic compounds, e.g., ionic or non-ionic polymers. Without being bound by theory, it is believed that the dispersant(s) may be adsorbed onto the particles and hinder close approach of particles by charge repulsion effects (e.g., in the case of ionic dispersants) or by steric effects (e.g., in the case of non-ionic dispersants).

In some examples, the composition may comprise from about 1% by weight to about 20% by weight of the dispersant(s) based on the total weight of the composition. For example, the composition may comprise from about 1% to about 15% by weight, from about 1% to about 10% by weight, from about 1% to about 5% by weight, from about 12% to about 17%, from about 7% to about 15%, from about 1% to about 3%, from about 2% to about 3.5% by weight, or from about 7% to about 12% by weight, based on the total weight of the composition. The dispersant(s) may be provided as a solid or a liquid, e.g., the dispersant being in liquid form and/or provided in a liquid medium such as water or a solvent.

Exemplary dispersants suitable for the compositions and methods herein include, but are not limited to, polymeric materials from synthetic or natural/renewable resources. For example, the dispersant(s) may comprise polymers and/or copolymers that include at least one functional group chosen from carboxyl, sulfate, phosphate, amine, ammonium, and/or silane. In some examples, the dispersant comprises an acrylic polymer, an acrylic copolymer, a styrene polymer, or a styrene copolymer. For example, the dispersant may comprise a polymer having a backbone derived from acrylic, methacrylic, allyl, or styrene monomers or combinations thereof. The dispersant may include a relatively hydrophobic backbone, e.g., to minimize the impact on water resistance. Exemplary dispersants suitable for the present disclosure include methacrylic polymers and methacrylic copolymers, which may have various functional groups such as carboxyl, sulfate, phosphate, amine, ammonium, and/or silane. The polymer or copolymer may be synthesized via chain-growth (addition) polymerization, such as free radical polymerization, or by step-growth (condensation) polymerization. According to some aspects herein, the dispersant comprises an acidic polymer with ammonium functional groups. For example, the dispersant may have an acid value ranging from about 20-50 mg KOH/g, and an amine value ranging from about 20-50 mg KOH/g. The dispersant may comprise a polymer or copolymer with a relatively narrow polydispersity (molecular weight distribution), such as between 1 and 3. A polydispersity of 1 means that all polymer chains have the same number of monomer units incorporated in all of the polymer chains and the same molar mass.

The amount of dispersant may be selected to provide suitable wetting and dispersing of solids within the composition without adverse effect on viscosity and stability.

The composition may comprise from about 10% by weight to about 40% by weight of the humectant based on the total weight of the composition. For example, the composition may comprise from about 10% to about 20% by weight, from about 30% to about 40% by weight, from about 15% to about 35% by weight, from about 30% to about 40% by weight, or from about 30% to about 40% by weight of one or more humectants, based on the total weight of the composition. According to some aspects of the present disclosure, the humectant comprises an alcohol. For example, the humectant may comprise a polyol such as glycerol (also known generally as glycerin). Other polyols and mixtures of polyols may be used in the compositions herein.

The compositions herein may comprise one or more additives such as, e.g., a rheology modifier, a surface tension agent, a de-foamer, and/or a biocide agent. For example, the compositions herein may comprise from about 0.1% by weight to about 5% by weight additive(s) chosen from rheology modifiers, de-foamers, surface tension agents, biocide agents, and combinations thereof. According to some aspects, the composition comprises from about 0.1% to about 3%, from about 0.5% to about 2.5%, from about 1% to about 4%, from about 0.5% to about 3.5%, from about 1.5% to about 5%, from about 2.5% to about 4% by weight of additives, wherein the additives comprise at least one de-foamer and at least one rheology modifier, and optionally one or more biocide agents and/or surface tension agents.

In at least one example, the composition comprises from about 0.1% by weight to about 0.5% by weight of one or more biocide agents (optionally in combination with one or more other additives), based on the total weight of the composition. For example, the composition may comprise from about 0.1% to about 0.3% by weight, from about 0.2% to about 0.5% by weight, or from about 0.3% to about 0.5% by weight of at least one biocide agent, based on the total weight of the composition. As used herein, biocide agents include any agent that destroys, neutralizes, or otherwise prevents microorganisms from growing within the composition, such biocide agents including insecticides, pesticides, fungicides, disinfectants, preservatives, and antiseptics. Exemplary biocide agents suitable for the compositions herein include, but are not limited to, benzisothiazolinone, methyl-4-isothiazolin-3-one, and other types of isothiazolinones.

In at least one example, the composition comprises from about 0.1% by weight to about 0.5% by weight of one or more de-foamers (optionally in combination with one or more other additives), based on the total weight of the composition. For example, the composition may comprise from about 0.1% to about 0.3% by weight, from about 0.2% to about 0.5% by weight, or from about 0.3% to about 0.5% by weight of at least one de-foamer, based on the total weight of the composition. Exemplary de-foamers include, but are not limited to, polydimethylsiloxanes, hydrophobized silica, and other silicone-based compounds, insoluble oils, waxes, stearates, and glycols, surfactants, inorganic compounds such as silicates and talc, hyper-branched polymers, and soy-based compounds, as well as any type of surfactants capable of promoting foam burst. In some examples, the de-foamer may comprise a silicone based compound blended with a mineral oil.

In at least one example, the composition comprises from about 0.1% by weight to about 3.0% by weight of one or more rheology modifiers (optionally in combination with one or more other additives), based on the total weight of the composition. For example, the composition may comprise from about 0.1% to about 2% by weight, from about 0.2% to about 3% by weight, from about 0.5% to about 1%, from about 1.5% to about 3%, from about 1% to about 2.5%, or from about 0.7% to about 1.2% by weight of at least one rheology modifier, based on the total weight of the composition. Exemplary rheology modifiers include, but are not limited to, thixotropic agents and thickeners. For example, the composition may comprise one or more rheology agents chosen from clays such as organo-clays and synthetic clays, hydrogenated castor wax, polyamides, silica such as fumed silica, colloidal silica, and phyllosilicates, cellulosic materials, and hydrophobically-modified materials such as hydrophobically modified ethoxylated urethane, hydrophobically-modified alkali-swellable emulsions, hydrophobically-modified hydroxy ethyl cellulose, and hydrophobically modified ethoxylated urethane alkali swellable emulsions. In some compositions, the rheology modifier(s) may be selected based at least in part on the type(s) and amount(s) of dispersant used. According to some aspects herein, the composition comprises a phyllosilicate as a rheology modifier, and an acidic polymer with ammonium functional groups as a dispersant.

In at least one example, the composition comprises from about 0.1% by weight to about 0.5% by weight of a surface tension agent (optionally in combination with one or more other additives), based on the total weight of the composition. Exemplary surface tension agents include, for example, surfactants. The compositions herein may comprise any combination of additives. For example, the composition may comprise at least one of each of a rheology modifier, a surface tension agent, a de-foamer, and a biocide. In some cases, an additive may serve as both a de-foamer and a surface tension agent, such as, e.g., a surfactant capable of serving as both a de-foamer and a surface tension agent.

Exemplary compositions according to the present disclosure include slurries prepared by combining the components listed in Table 1.

TABLE 1

| | Amount (% wt) |
|---|---|
| Alkali activator | 20-80% |
| Humectant | 3-20% |
| Dispersant | 1-10% |
| Biocide agent | 0.1-1% |
| De-foamer | 0.1-0.5% |
| Rheology modifier | 0.1-3% |
| Other additives | 0.1-5% |
| Water | q.s. up to 100% |

In at least one example, the composition comprises about 20% by weight to about 75% by weight anhydrous sodium sulfate, about 1% by weight to about 20% by weight of a dispersant, about 10% by weight to about 40% by weight of a humectant, at least one additive chosen from a rheology modifier, a de-foamer, a biocide agent, or a combination thereof, and water. Such compositions may be in the form of a slurry, a dispersion, a suspension, or an emulsion, for example.

Compositions according to the present disclosure may be prepared by combining the activator, e.g., anhydrous sodium sulfate and/or biopolymer blend, with the dispersant, the humectant, and the additive(s) before adding water. When combined, the sodium sulfate, dispersant, humectant, and additive(s) may form a mixture, such as a homogeneous paste. Thereafter, the mixture may be combined with water, and optionally one or more other additives, to form the composition, e.g., useful as a liquid chemical activator. In some examples, the humectant, dispersant, and additive(s) may be first combined to form a blend, and the blend then combined with the sodium sulfate to form the mixture or homogeneous paste. For example, an exemplary composition may be prepared by combining the humectant, dispersant and at least one additive (e.g., a biocide agent) to form a blend, combining the blend with anhydrous sodium sulfate to form a mixture, combining the mixture with water to form a slurry, and optionally adding another additive (e.g., a rheology modifier, de-foamer, and/or other additives) to the slurry.

A difference in surface energy between the sodium sulfate and liquids (polymers and solvents) may result in an inhomogeneous material if one were to combine all components in a single step. In the methods herein, however, the dispersant(s) may prevent re-association of the solid/powder sodium sulfate particles as discussed above by adsorbing onto the particles. This adsorption may hinder close approach of particles by charge repulsion effects (e.g., in the case of ionic dispersants) or by steric effects (e.g., in the case of non-ionic dispersants).

The composition may comprise at least 10% by weight solids, e.g., from about 10% by weight to about 80% by weight solids, based on the total weight of the composition. The composition may be in the form of a slurry, a dispersion, a suspension or an emulsion. The composition may have a pH value greater than or equal to 8, such as a pH between 8 and about 14, between about 10 and about 12, between about 10 and about 14, or between about 9 and about 13. The pH of the composition may affect stability of the composition. Stability refers to having limited to no settlement of solids or phase separation during storage. For example, the composition may have no visible phase separation, that is, no visible formation of a separate fluid layer above a solids layer (e.g., less than 5% by volume, such as less than 1% by volume, of the fluid present in the composition forms a top fluid layer). Stability further may be quantified as a percentage by volume, measuring the height of the fluid layer separated at the top and the total height of the slurry in the cylindrical vessel For example, the composition may be stable for at least one week, at least two weeks, or one month or more at temperature conditions typical of storage (e.g., a temperature between 2° C. and 45° C.).

The compositions herein may have a Brookfield viscosity ranging from about 500 cP to about 3500 cP, such as from about 1000 cP to about 3500 cP, from about 500 cP to about 2000 cP, from about 1500 cP to about 3000 cP, from about 2500 cP to about 3500 cP, or from about 2000 cP to about 3500 cP. The viscosity of the composition maybe controlled by the chemical composition, including the amount of solids, the presence or absence of additives such as rheology modifiers and de-foamers at different levels of use, as well as the processing conditions and equipment (pumping, milling, mixing etc.).

As mentioned above, the compositions herein may be used in cementitious compositions, e.g., as cement mixtures useful in the preparation of concrete. For example, the compositions herein may serve as an activator for various SCMs to control setting time and promote early strength development and/or durability of concrete. According to some aspects of the present disclosure, the composition may replace at least 50% by weight of a cement. For example, a cement mixture according to the present disclosure may comprise at least 50% by weight of the composition (e.g., a slurry, dispersion, suspension, or emulsion comprising anhydrous sodium sulfate, a dispersant, a humectant, water, and one or more additives) and one or more SCMs, and less than 50% by weight General Purpose (GP) cement (formerly called Portland cement), such as less than or equal to 40% by weight, less than or equal to 35% by weight, less than or equal to 30% by weight, less than or equal to 25% by weight, or less than or equal to 20% by weight GP cement. The cement mixtures herein may comprise GP cement in combination with one or more SCMs (industrial waste materials or by-products from the mining industry, the minerals processing industry or agricultural products or other types of raw naturally derived products) and optionally another cement, such as Shrinkage Limited (SL) cement. An exemplary SCM useful together with GP cement and/or SL cement is GGBFS (slag). For example, another exemplary cement mixture comprises at least 50% by weight of an alkali activator composition (e.g., a slurry, dispersion, suspension, or emulsion comprising anhydrous sodium sulfate, a dispersant, a humectant, water, and one or more additives) and at least one SCM, and less than 50% by weight GP cement and SL cement, such as less than or equal to 40% by weight, less than or equal to 35% by weight, less than or equal to 30% by weight, less than or equal to 25% by weight, or less than or equal to 20% by weight of a total of GP+SL cement. The cement mixture may further comprise one or more cementitious materials, such as, e.g., slag (e.g., ground granulated blast-furnace slag (GGBFS)), fly ash, silica fume, or a combination thereof.

Also included herein are concrete compositions prepared from such cement mixtures, e.g., a composition according to the present disclosure (e.g., a slurry, dispersion, suspension, or emulsion comprising anhydrous sodium sulfate, a dispersant, a humectant, water, and one or more additives) and one or more cement such as GP cement and/or SL cement. The concrete composition may comprise a cement mixture as discussed above and one or more aggregates. Exemplary aggregates include, but are not limited to, granite, granodiorite, silica, basalt, quartz, laterite, and limestone. The aggregate or mixture of aggregates may comprise coarse aggregates and/or fine aggregates. For example, the aggregate may comprise sand (e.g., granite dust such as manufactured sand and/or washed fine sand) which is typically a fine aggregate, and/or a coarse aggregate such as granite and/or granodiorite. The average particle size of some aggregates (e.g., coarse aggregates) may range from about 5 mm to about 30 mm, such as about 10 mm to about 20 mm. Particle size of aggregates and measurement thereof is specified in AS2758.1. In at least one example, the concrete composition comprises a coarse aggregate of particle size 10 mm and a coarse aggregate of particle size 20 mm, optionally in combination with one or more other aggregates. In another example, the concrete composition comprises a coarse aggregate blend of particle size 10 mm, 14 mm, and 20 mm, optionally in combination with one or more other aggregates.

The concrete composition may be prepared by combining the cement mixture with the one or more aggregates, water, and optionally one or more additives or admixtures (such as water reducers, accelerators, retarders, specialty admixtures or various combinations of such admixtures), and then allowing the resulting concrete composition to set over a period of time. The concrete composition may have an initial setting time less than or equal to 4.5 hours and/or a final setting time less than or equal to 6 hours, e.g., an initial setting time less than or equal to 4.0 hours and/or a final setting time less than or equal to 6.5 hours. The initial setting time may be measured as the time required for a mortar made from the concrete to reach 3.5 MPa, and the final setting time may be measured as the time for the mortar to reach 28 MPa (see standard AS1012.18-1996). AS1012.18-1996 defines both the initial setting time and final setting time as the time required for a mortar sieved from the actual concrete mix to achieve the specified penetration resistance.

The concrete compositions herein may have an air content less than or equal to 7% by volume, such as less than or equal to 6.5% by volume, less than or equal to 6.0% by volume, less than or equal to 5.5% by volume, less than or equal to 5.0% by volume, less than or equal to 4.5% by volume, or less than or equal to 4.0% by volume, based on the total volume of the concrete composition. For example, the concrete composition may have an air content ranging from about 3% by volume to about 7% by volume, or from about 3.5% by volume to about 5.5% by volume. Air content and the yield of a concrete load may be measured according to standard AS1012.4.2. In some examples, the addition of a de-foamer may help to reduce air content, e.g., by at least 1% or at least 2%.

Further, for example, the concrete compositions herein may have a compressive strength greater than or equal to 20 MPa at 28 days, such as greater than or equal to 25 MPa at 28 days, or greater than or equal to 30 MPa at 28 days. For example, the concrete composition may have a compressive strength ranging from about 20 MPa to about 60 MPa at 28 days, e.g., a compressive strength ranging from about 30 MPa to about 55 MPa, or ranging from about 40 MPa to about 55 MPa at 28 days. Compressive strength may be measured according to standard AS1012.9.

### EXAMPLES

The following examples are intended to illustrate the present disclosure without being limiting in nature. It is understood that the present disclosure encompasses additional embodiments consistent with the foregoing description and following examples.

The examples below on preparation of slurries used some or all of the following components: dispersant=either a styrene modified copolymer in water with an acid value of 20 mg KOH/g and an amine value of 20 mg KOH/g, or a solution of an alkylol ammonium salt of a high molecular weight acidic polymer (manufacturer BYK Altana), having an amine value of 41 mg KOH/g and an acid value of 46 mg KOH/g; biocide=Acticide® MBS, a broad spectrum microbial preservation comprising 2.5% 2-methyl-4-isothiazolin-3-one (MIT) and 2.5% 1,2-8-benzisothiazolin-3-one (BIT) (manufacturer Thor); rheology modifier=Optigel WX, a modified/activated phyllosilicate (manufacturer BYK); de-foamer=BYK-1630, a mixture of paraffin based mineral oils and hydrophobic components including silicone (manufacturer BYK); alkali activator=sodium sulfate anhydrous, 99% purity (manufacturer Redox); humectant glycerine, purity >98% (manufacturer Recochem). The examples below on preparation of concrete used some or all of the following components: General Purpose (CP) cement comprising 63% wt. CaO, 19.4% wt. SiO2, and 0.6% wt. Na₂O equivalent (Cockburn Cement Limited); Shrinkage Limited (SL) cement comprising more than 87.5% wt. GP cement, less than 7.5% wt. slag, 0.35% wt. Na₂O equivalent (Boral); ground granulated blast-furnace slag (GGBFS) comprising 45% CaO, 32% SiO2, and 0.4% Na₂O equivalent (Cockburn Cement Limited); Plastiment® BV35, a lignosulfonate based water reducing admixture (Sika); and Plastiment® 10, a lignosulfonate and polycarboxylate based water reducing admixture (Sika).

### Example 1

A slurry (LAA1) was prepared with the following components:

TABLE 2

| | Amount (g) | Amount (% wt.) |
|---|---|---|
| Sodium sulfate anhydrous | 1950 | 65.0% |
| Glycerine | 360 | 13.2% |
| Polymeric dispersant | 105 | 2.3% |
| Acticide ® MBS | 9-11 | 0.3-0.4% |
| Optigel WX | 16 | 0.5% |
| Water | 489-491 | 18.6-18.7% |

The slurry was prepared in a stainless-steel reactor using a high-speed disperser or a manual stick blender (VB250 Vitablend Stick Blender from Semak Australia). A thick paste was made up firstly by stirring in at high speed (500-1000 rpm) the sodium sulfate anhydrous (SSA) into a blend of glycerine, Acticide® MBS (9 g), and polymeric dispersant. Once the SSA powder was incorporated into the blend, water (230 g) was added to form a homogeneous, thick paste. A rheology modifier was then added in one of two ways: (1) as a pre-gel comprising 16 g Optigel WX in 309 g of water and 2 g Acticide® MBS; allowing at least 4 hours for gel formation), or (2) as powder Optigel WX (16 g) mixed in water (311 g). After adding the rheology modifier, a further 20 g of water was added to form a consistent, low viscosity, stable, slurry. The maximum temperature developed during the slurry preparation was in the range 32° C.-38° C. The slurry was found to be stable at 20° C.-25° C. for at least six months with minimal change in viscosity or phase separation (no solid material settled over time was observed). The slurry was used in preparing environmentally friendly, low CO2 concrete manufacturing.

### Example 2

A slurry (LAA2) was prepared with the following components:

TABLE 3

| | Amount (g) | Amount (% wt.) |
|---|---|---|
| Sodium sulfate anhydrous | 1950 | 66.5% |
| Glycerine | 360 | 12.3% |
| Polymeric dispersant | 105 | 3.6% |
| Acticide ® MBS | 9-11 | 0.3-0.4% |
| Optigel WX | 16 | 0.5% |
| Water | 560-562 | 16.7-16.8% |

The slurry was prepared according to Example 1 in a stainless-steel reactor using a high-speed disperser or a manual stick blender. A thick paste was made up firstly by stirring in at high speed (500-1000 rpm) the SSA into a blend of glycerine, Acticide® MBS (9 g), and polymeric dispersant, followed by addition of water (150 g) to form a homogeneous, thick paste. A rheology modifier was then added in one of two ways: (1) as a pre-gel comprising 16 g Optigel WX in 309 g of water and 2 g Acticide® MBS), or (2) as powder Optigel WX (16 g) mixed in water (311 g). A further 30 g of water was then added to form a consistent, low viscosity, stable slurry. The maximum temperature developed during the slurry preparation was in the range 32° C.-38° C. The slurry was found to be stable at 20° C.-25° C. for at least six months with minimal change in viscosity or phase separation (no solid material settled over time was observed). The slurry was used in preparing environmentally friendly, low CO concrete manufacturing.

### Example 3

A slurry (LAA3) was prepared with the following components:

TABLE 4

| | Amount (g) | Amount (% wt.) |
|---|---|---|
| Sodium sulfate anhydrous | 1950 | 64.4% |
| Crude glycol | 570 | 18.8% |
| Polymeric dispersant | 45 | 1.5% |
| Acticide ® MBS | 9 | 0.3% |
| Optigel WX | 21 | 0.7% |
| Water | 432 | 14.3% |

The slurry was prepared according to Example 1 in a stainless-steel reactor using a high-speed disperser or a manual stick blender. A thick paste was prepared by stirring in at high speed (500-1000 rpm) an amount of 1950 solid SSA (natural grade or manufactured grade) into a blend of crude glycol as humectant, Acticide® MBS, and polymeric dispersant, followed by addition of water (50 g) to form a homogeneous, thick paste. The rheology modifier was added in as a powder (18 g of Optigel WX) together with 382 g water. A further 3 g Optigel WX powder was post-added in for better rheology and homogeneity of the slurry. The maximum temperature developed during the slurry preparation was in the range 36° C.-39° C. The slurry was relatively stable at 20° C.-25° C. for at least three months with minimal change in viscosity. A minor degree of phase separation was noticed after a couple of days. This was attributed to lower amounts of dispersant and/or the humectant wetting out the SSA powder to a lesser degree compared glycerine. No solid material was observed to settle over time. The slurry was used as such as an admixture (with stirring prior to use) in environmentally friendly, low CO2 concrete manufacturing.

### Example 4

A slurry (LAA4) was prepared as described in Example 3, but adding slightly more Optigel WX (22 g) to investigate the effect on phase separation. The maximum temperature developed during the slurry preparation was in the range 36° C.-40° C. The slurry was stable at 20° C.-25° C. for at least three months with minimal change in viscosity. No phase separation was observed and no solid material settled over time. The slurry was used as such as an admixture in environmentally friendly, low CO2 concrete manufacturing.

### Example 5

A slurry (LAA5) was prepared with the following components:

TABLE 5

| | Amount (g) | Amount (% wt.) |
|---|---|---|
| Sodium sulfate anhydrous | 980 | 70.1% |
| Glycerine | 182 | 13.0% |
| Polymeric dispersant | 42 | 3.0% |
| Acticide ® MBS | 4 | 0.3% |
| Optigel WX | 8 | 0.6% |
| Water | 182 | 13.0% |

The slurry was prepared according to procedure described in Example 1 in a stainless-steel reactor using a high-speed disperser or a manual stick blender. A thick paste was made up firstly by stirring in at high speed (500-1000 rpm) the SSA into a blend of glycerine, Acticide® MBS, and polymeric dispersant, followed by addition of water (98 g) to form a homogeneous, thick paste. The Optigel WX was added together with water (84 g). The maximum temperature developed during the slurry preparation was in the range 36° C.-38° C. The slurry was found to be stable at 20° C.-25° C. with minimal change in viscosity. No phase separation was observed, and no solid material settled over time. The slurry was used in preparing environmentally friendly, low CO2 concrete manufacturing.

### Example 6

Two concrete samples C1-LAA1 and C1-LAA2 were prepared using the slurries LAA1 and LAA2, respectively, for comparison to a control prepared with sodium sulfate anhydrous (SSA), as summarized in Table 6:

TABLE 6

| | | |
|---|---|---|
| Control | C1-LAA1 | C1-LAA2 |

CONCRETE COMPOSITION

| | | | | |
|---|---|---|---|---|
| GP Cement | kg | 7 | 7 | 7 |
| GGBFS | kg | 7 | 7 | 7 |
| SSA | kg | 0.36 | — | — |
| LAA1 | kg | — | 0.54 | — |
| LAA2 | kg | — | — | 0.55 |
| Granite 20 mm aggregate | kg | 30 | 30 | 30 |
| Granite 10 mm aggregate | kg | 18 | 18 | 18 |
| Manufactured Sand | kg | 11 | 11 | 11 |
| (granite dust) | | | | |
| Washed fine sand | kg | 16 | 16 | 16 |
| Plastiment ® BV35 | mL | 50 | 51 | 51 |
| Water | kg | 7.3 | 7.3 | 6.7 |

CONCRETE PROPERTIES

| | | | | |
|---|---|---|---|---|
| Slump | mm | 80 | 80 | 80 |
| (Standard AS1012.3.l) | | | | |
| Fresh concrete density | kg/m³ | 2430 | 2380 | 2380 |
| AS 1012.5 | | | | |
| Water/Cement Ratio | | 0.50 | 0.50 | 0.50 |
| Compressive strength (MPa) | 1 day | 5.5 | 8.5 | 6.0 |
| (Standard AS1012.9) | 3 days | 26 | 26 | 23.5 |
| | 7 days | 40 | 40 | 38.5 |
| | 28 days | 51.5 | 52 | 49.5 |
| Drying shrinkage | 7 days | 80 | 80 | 130 |
| (micro-strains) | 14 days | 130 | 130 | 170 |
| (Standard AS1012.13 | 21 days | 170 | 170 | 210 |
| | 28 days | 190 | 180 | 220 |
| | 56 days | 250 | 240 | 300 |
| Water permeability (mm) | | 6 | 5 | 5 |
| (Standard DIN1048 Part 5) | | | | |

This set of concrete experiments was conducted in a pan mixer, at a 40 L scale and the target mix design was a 40 MPa concrete product with a 50/50 blend of GP cement and GGBFS (175 kg/m³ of each), using an amount of alkali activator of 9 kg/m³ solid SSA or a slurry (LAA1 or LAA2). The target compressive strength of 40 MPa was met at 7 days in all three cases, but the one day strength of the concrete samples prepared using LAA1 and LAA2 was superior to the control when powder SSA was employed. The compressive strength values were comparable after the first day with 28 days strengths of around 50 MPa, above target. The drying shrinkage results were below 300 microstrain at 56 days, showing improvement for the LAA1 based concrete in comparison to the control prepared with powder SSA. The water permeability also improved when LAA1 and LAA2 slurries were used compared to SSA powder.

### Example 7

Four concrete samples (C2.3-LAA2, C2.4-LAA2, C2.5-LAA1, and C2.6-LAA1) were prepared using the slurries LAA1 and LAA2 for comparison to controls prepared with dry powder SSA, as summarized in Table 7:

TABLE 7

| | | | | C2.3- | C2.4- | C2.5- | C2.6- |
|---|---|---|---|---|---|---|---|
| | | Control | Control | LAA2 | LAA2 | LAA1 | LAA1 |
| SL Cement | kg/m³ | 300 | 300 | 290 | 290 | 290 | 290 |
| SSA | kg/m³ | 0 | 0 | — | — | — | — |
| LAA1 | kg/m³ | — | — | — | — | 13.5 | 13.1 |
| | | | | | | (8.76 | (8.73 |
| | | | | | | SSA) | SSA) |
| LAA2 | kg/m³ | — | — | 8.7 | 8.7 | — | — |
| 20 mm aggregate (granodiorite) | kg/m³ | 740 | 740 | 720 | 720 | 720 | 720 |
| 10 mm aggregate (granodiorite) | kg/m³ | 290 | 290 | 280 | 280 | 280 | 280 |
| Manufactured Sand | kg/m³ | 450 | 450 | 440 | 440 | 440 | 440 |
| Washed Fine Sand | kg/m³ | 380 | 380 | 370 | 370 | 370 | 370 |
| Water | kg/m³ | 208 | 210 | 200 | 200 | 202 | 202 |
| Slump | mm | 80 | 80 | 80 | 80 | 80 | 80 |
| (Standard AS1012.3.1) | | | | | | | |
| Fresh concrete density | kg/m³ | 2365 | 2365 | 2305 | 2305 | 2310 | 2305 |
| (Standard AS1012.5) | | | | | | | |
| Water/Cement Ratio | | 0.69 | 0.7 | 0.69 | 0.69 | 0.69 | 0.69 |
| Air content | % vol. | 1.4 | 1.4 | 4.4 | 4.5 | 4.5 | 4.6 |
| (Standard AS1012.4.2) | | | | | | | |
| Bleeding | % wt. | 1.3 | 1.5 | 0 | 0 | 0 | 0 |
| (Standard AS1012.6) | | | | | | | |
| Setting time (initial) | h:min | 4:10 | 4:00 | 3:20 | 3:30 | 3:30 | 3:30 |
| Setting time (final) | h:min | 5:40 | 5:40 | 4:30 | 4:40 | 4:50 | 4:40 |
| Compressive strength (MPa) | 1 day | 9.8 | 9.3 | 15.5 | 16 | 17 | 15.5 |
| (Standard AS1012.9) | 3 days | 22 | 20.5 | 23 | 23.5 | 22.5 | 25 |
| | 3 days | 21 | 21 | 23.5 | 24 | 24.5 | 25 |
| | 7 days | 28.5 | 26 | 27.5 | 29 | 28 | 28 |
| | 7 days | 27 | 25.5 | 27.5 | 28 | 28.5 | 28 |
| | 28 days | 35.9 | 33.6 | 34.2 | 33 | 33.2 | 31.8 |
| | 28 days | 36.2 | 35.2 | 34.9 | 32.6 | 32.3 | 32.1 |
| | 28 days | 36.7 | 34.4 | 34.3 | 32.8 | 31.8 | 32.5 |
| | 56 days | 39.4 | 35.8 | 35.8 | 33.5 | 34 | 34.3 |
| | 90 days | 40.8 | 37.8 | 37.4 | 36 | 36.3 | 37 |
| | 90 days | 41.5 | 38 | 37.1 | 37.7 | 36.6 | 35.6 |
| Drying shrinkage (micro-strains) | 7 days | 230 | 220 | 260 | 250 | 270 | 250 |
| (Standard AS1012.13) | 14 days | 340 | 340 | 350 | 340 | 370 | 340 |
| | 21 days | 450 | 440 | 440 | 430 | 460 | 430 |
| | 28 days | 480 | 480 | 470 | 460 | 490 | 460 |
| | 56 days | 620 | 620 | 620 | 610 | 630 | 610 |

The control sample was manufactured in duplicate, as well as the samples using LAA1 and LAA2 (at 3% wt. SSA) on the total amount of binder at a 50 L scale (amounts in Table 7 being reported for one cubic meter of concrete). Less water was added in the case when LAA1 and LAA2 were used as the solid and liquid contents of the slurries were accounted for (the corresponding dry SSA amounts listed in brackets for the LAA1 slurry and LAA2 slurry). The water to cement ratios were similar. The air contents were higher when the LAA slurries were used (4.5% vol. against 1.5% vol. in the control samples), and this observation was consistent for all the experiments conducted; therefore a de-foamer was added in the initial LAA formulations (see Example 5). No bleeding of concrete was noticed when the LAA slurries were used, which may be due to the hygroscopic nature of the sodium sulfate. The concrete made with LAA slurries set up with 30-60 minutes earlier than the controls. The early compressive strength was particularly high at one day, above 15 MPa, which represents almost half of the target compressive strength at 28 days.

### Example 8

Two concrete samples (C3.1-LAA2 and C3.2-LAA2) were prepared using the slurries LAA1 and LAA2 for comparison to controls prepared with dry powder SSA, as summarized in Table 8:

TABLE 8

| | | | |
|---|---|---|---|
| Control | Control | C3.1-LAA2 | C3.2-LAA2 |

CONCRETE COMPOSITION

| | | | | | |
|---|---|---|---|---|---|
| SL Cement | kg/m³ | 305 | 305 | 295 | 295 |
| SSA | kg/m³ | 0 | 0 | — | — |
| LAA2 | kg/m³ | — | — | 13.38 (8.9 | 13.38 (8.9 |
| | | | | SSA) | SSA) |
| 20 mm aggregate (granodiorite) | kg/m³ | 750 | 750 | 730 | 730 |
| 10 mm aggregate (granodiorite) | kg/m³ | 290 | 290 | 280 | 280 |
| Manufactured Sand | kg/m³ | 460 | 460 | 450 | 450 |
| Washed Fine Sand | kg/m³ | 390 | 390 | 380 | 380 |
| Water | kg/m³ | 202 | 202 | 194 | 194 |

CONCRETE PROPERTIES

| | | | | | |
|---|---|---|---|---|---|
| Slump | mm | 80 | 80 | 80 | 80 |
| (Standard AS1012.3.l) | | | | | |
| Fresh concrete density | kg/m³ | 2390 | 2380 | 2340 | 2330 |
| (Standard AS1012.5) | | | | | |
| Water/Cement Ratio | | 0.67 | 0.67 | 0.65 | 0.65 |
| Air content | % vol. | 1.3 | 1.3 | 3.9 | 4 |
| (Standard AS1012.4.2) | | | | | |
| Bleeding | % wt. | 1.4 | 2 | 0.2 | 0.1 |
| (Standard AS1012.6) | | | | | |
| Setting time (initial) | h:min | 4:05 | 3:50 | 3:15 | 3:05 |
| Setting time (final) | h:min | 5:35 | 5:30 | 4:20 | 4:35 |
| Compressive strength (MPa) | 1 day | 10.1 | 9.2 | 16.7 | 17.9 |
| (Standard AS1012.9) | 3 days | 21.1 | 21.3 | 23.2 | 23.5 |
| | 7 days | 27.7 | 27.4 | 25.6 | 27.5 |
| | 28 days | 34.9 | 34.6 | 32.4 | 32.8 |
| | 56 days | 39.7 | 38.6 | 35.2 | 34.6 |
| | 90 days | 40.6 | 40.2 | 36.9 | 34.8 |
| Drying shrinkage (micro-strains) | 7 days | 180 | 200 | 190 | 190 |
| (Standard AS1012.13) | 14 days | 290 | 310 | 260 | 270 |
| | 21 days | 370 | 390 | 310 | 320 |
| | 28 days | 440 | 460 | 350 | 350 |
| | 56 days | 560 | 590 | 450 | 470 |

This set of four experiments was conducted by following the provisions of AS1478.1-2000 for concrete testing/approval, targeting a 32 MPa concrete product with SL (Shrinkage Limited) cement against control samples without alkali activator. Samples were prepared at a 50 L scale (amounts in Table 8 being reported for one cubic meter of concrete). There was a 3% reduction in the cement content when the activator was employed in comparison with the control that was within the admissible tolerance. The amount of solid alkali activator to the binder was 3% wt. SSA; the total water was accounted for so that the target water/cement ratio was about the same, around 0.65-0.67. The air content for the concrete samples prepared using the slurries was again higher in comparison to the control samples. The bleed of the concrete samples with LAA2 was almost negligible. The setting time was again 30-60 minutes shorter than for the control samples. The samples prepared with LAA2 exhibited good early compressive strength; above the 50% target strength of 32 MPa was met at one day. The shrinkage at 56 days was below 500 microstrain, an improvement when compared to GP cement based 32 MPa concrete, which normally exhibits values above 600 microstrain.

### Example 9

A concrete sample was prepared using LAA2 prepared as described in Example 2, summarized in Table 9:

TABLE 9

C4-LAA2

CONCRETE COMPOSITION

| | | |
|---|---|---|
| SL Cement | kg/m³ | 145 |
| LAA2 | kg/m³ | 6.4 (including |
| | | 4.42 SSA) |
| GGBFS | kg/m³ | 145 |
| 20 mm aggregate (granodiorite) | kg/m³ | 720 |
| 10 mm aggregate (granodiorite) | kg/m³ | 280 |
| Manufactured Sand | kg/m³ | 440 |
| Washed Fine Sand | kg/m³ | 380 |
| Water | kg/m³ | 196 |

CONCRETE PROPERTIES

| | | |
|---|---|---|
| Slump | mm | 80 |
| (Standard AS1012.3.l) | | |
| Fresh concrete density | kg/m³ | 2310 |
| (Standard AS1012.5) | | |
| Water/Cement Ratio | | 0.66 |
| Air content | % vol. | 4 |
| (Standard AS1012.4.2) | | |
| Bleeding | % wt. | 0.4 |
| (Standard AS1012.6) | | |
| Setting time (initial) | h:min | 4:25 |
| Setting time (final) | h:min | 6:45 |
| Compressive strength (MPa) | 1 day | 5.6 |
| (Standard AS1012.9) | 3 days | 14.8 |
| | 7 days | 27.8 |
| | 28 days | 39.2 |
| | 56 days | 42.2 |
| Drying shrinkage (micro-strains) | 7 days | 140 |
| (Standard AS1012.13) | 14 days | 200 |
| | 21 days | 240 |
| | 28 days | 290 |
| | 56 days | 390 |

This experiment was conducted with LAA2 (66.5% solid SSA content) prepared according to Example 2 in a concrete product with 290 kg/m binder comprising a 50/50 blend of GP cement and GGFBS slag. Samples were prepared at a 50 L scale (amounts in Table 9 being reported for one cubic meter of concrete). The air content was relatively high at 4% vol. and the bleeding was negligible (0.4%), as observed in most of the other working examples. The compressive strength growth was comparable to a 100% GP concrete mix and the shrinkage values were relatively low (below 400 microstrain at 56 days).

### Example 10

Two different concrete samples were prepared as summarized in Table 10:

TABLE 10

| | |
|---|---|
| Control | C5-LAA2 |

CONCRETE COMPOSITION

| | | | |
|---|---|---|---|
| SL Cement | kg/m³ | 213 | 210 |
| SSA (dry powder) | kg/m³ | 10.7 | — |
| LAA2 | kg/m³ | — | 15.8 (10.5 |
| | | | SSA) |
| GGBFS | kg/m³ | 202 | 199 |
| 20 mm aggregate (granodiorite) | kg/m³ | 788 | 775 |
| 10 mm aggregate (granodiorite) | kg/m³ | 392 | 385 |
| Manufactured Sand | kg/m³ | 396 | 389 |
| Washed Fine Sand | kg/m³ | 239 | 200 |
| Water | kg/m³ | 176 | 185 |
| Plastiment ® 10 | mL/100 kg | 407 | 399 |

CONCRETE PROPERTIES

| | | | |
|---|---|---|---|
| Slump | mm | 120 | 130 |
| (Standard AS1012.3.l) | | | |
| Fresh concrete density | kg/m³ | 2510 | 2488 |
| (Standard AS1012.5) | | | |
| Water/Cement Ratio | | 0.412 | 0.436 |
| Air content | % vol. | 1.6 | 2.2 |
| (Standard AS1012.4.2) | | | |
| Compressive strength (MPa) | 1 day | 15.2 | 13.8 |
| (Standard AS1012.9) | 3 days | 34.1 | 27.1 |
| | 7 days | 47.7 | 43.5 |
| | 28 days | 53.5 | 53.2 |
| | 56 days | 58.6 | 56.1 |
| Drying shrinkage (micro-strains) | 7 days | 100 | 120 |
| (Standard AS1012.13) | 14 days | 130 | 150 |
| | 21 days | 150 | 170 |
| | 28 days | 180 | 200 |
| | 56 days | 230 | 240 |

A mix with 120 mm slump was targeted in this set of experiments (400 kg/m³ cementitious materials, a 50/50 blend of GP and GGBFS; activators were SSA powder and LAA2 at 65% SSA by weight). Samples were prepared at a 50 L scale (amounts in Table 10 being reported for one cubic meter of concrete). A higher water to cement ratio was achieved for the sample prepared with slurry C5-LAA2 (0.44 vs 0.41). A PCE type water reducing admixture Plastiment® 10 was used at around 400 mL/100 kg cementitious materials and the air contents were comparable at around 2% vol. (the entrapped air content halved upon the introduction of the admixture for the concrete made with the LAA2 slurry). The compressive strength and shrinkage results were acceptable; slightly better values for the control may be attributed to its lower water/cement ratio.

### Example 11

Four different concrete samples, including three samples with slurries LAA3, LAA4, and LAA1) were prepared as summarized in Table 11:

TABLE 11

| | | | | |
|---|---|---|---|---|
| Control | Control | C6-LAA3 | C6-LAA4 | C6-LAA1 |

CONCRETE COMPOSITION

| | | | | | | |
|---|---|---|---|---|---|---|
| SL Cement | kg/m³ | 151 | 151 | 149 | 149 | 147 |
| SSA (dry powder) | kg/m³ | 4.5 | 4.5 | — | — | — |
| LAA1 | kg/m³ | — | — | — | — | 6.8 |
| LAA3 | kg/m³ | — | — | 6.9 | — | — |
| LAA4 | kg/m³ | — | — | — | 6.9 | — |
| GGBFS | kg/m³ | 151 | 151 | 149 | 149 | 147 |
| 20 mm aggregate (granodiorite) | kg/m³ | 743 | 745 | 732 | 732 | 724 |
| 10 mm aggregate (granodiorite) | kg/m³ | 287 | 288 | 283 | 283 | 280 |
| Manufactured Sand | kg/m³ | 456 | 457 | 449 | 449 | 444 |
| Washed Fine Sand | kg/m³ | 387 | 387 | 381 | 381 | 377 |
| Water | kg/m³ | 204 | 205 | 198 | 198 | 198 |

CONCRETE PROPERTIES

| | | | | | | |
|---|---|---|---|---|---|---|
| Slump | mm | 80 | 80 | 85 | 80 | 85 |
| (Standard AS1012.3.1) | | | | | | |
| Fresh concrete density | kg/m³ | 2379 | 2385 | 2340 | 2341 | 2317 |
| (Standard AS1012.5) | | | | | | |
| Water/Cement Ratio | | 0.670 | 0.680 | 0.660 | 0.670 | 0.670 |
| Air content | % vol. | 1.4 | 1.4 | 3.4 | 3.5 | 4.2 |
| (Standard AS1012.4.2) | | | | | | |
| Bleeding | % wt. | 1 | 1 | 1.4 | 1.4 | 1.1 |
| (Standard AS1012.6) | | | | | | |
| Setting time (initial) | h:min | 3:20 | 3:30 | 3:30 | 3:50 | 3:40 |
| Setting time (final) | h:min | 5:35 | 5:35 | 5:10 | 5:40 | 5:55 |
| Compressive strength (MPa) | 1 day | 7 | 7.1 | 6.3 | 6.9 | 6.3 |
| (Standard AS1012.9) | 3 days | 16.9 | 15.5 | 13.4 | 17.2 | 17.2 |
| | 7 days | 26.8 | 25.6 | 25.4 | 24.2 | 29 |
| | 28 days | 33 | 34.2 | 30.9 | 31.7 | 36.4 |
| Drying shrinkage (micro- | 7 days | 130 | 140 | 140 | 150 | 150 |
| strains) | 14 days | 170 | 190 | 180 | 220 | 200 |
| (Standard AS1012.13) | 21 days | 200 | 230 | 190 | 230 | 220 |
| | 28 days | 230 | 240 | 220 | 260 | 240 |
| | 56 days | 350 | 380 | 320 | 390 | 360 |

This set of comparative experiments was conducted in order to make 32 MPa concrete with 3% wt. SSA solid relative to the amount of GGBFS (serving as a SCM), in a binder system GP/slag=50/50 (150 kg/m³ of each). Samples were prepared at a 50 L scale (amounts in Table 11 being reported for one cubic meter of concrete). Three different slurries were used; LAA1, LAA3, and LAA4 prepared as discussed above. Best results were observed for the LAA1 based concrete prepared using glycerin rather than a blend of glycols as a humectant. It was noticed that the stability of the slurries made with glycerin was superior to the ones that used glycols to wet out the SSA powder. The water/cement ratios of the concrete samples were similar in the five samples (0.66-0.68); the water/liquids in the slurries were accounted for when the water was adjusted for the samples made with powder SSA. The air content was higher for the concrete samples made with slurries in comparison to the concrete made with powder SSA as an alkali activator. The concrete bleeding values were relatively similar, around 1% in each case. The setting times were comparable among the samples. The compressive strength values were relatively similar; the highest values were exhibited for the sample prepared with LAA1 (using glycerin as a humectant). The shrinkage values were all below 400 microstrain at 56 days.

Embodiments have been described herein by way of example, with reference to various possible features and functions. Such embodiments are intended to be illustrative rather than restrictive. It should be understood that embodiments include various combinations and sub-combinations of features described herein, even if such features are not explicitly described in such a combination or sub-combination.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

It is intended that the specification and examples be considered as exemplary only, with a true scope and spirit of the present disclosure being indicated by the following claims.

1. A composition comprising:
an activator comprising anhydrous sodium sulfate and/or an alkali biopolymer;
a dispersant;
a humectant;
at least one additive chosen from a rheology modifier, a de-foamer, a biocide agent, a surface tension agent, or a combination thereof; and
water;
wherein the composition comprises about 20% by weight to about 80% by weight solids, based on the total weight of the composition.

2. The composition of claim 1, wherein the composition is in the form of a slurry, a dispersion, a suspension, or an emulsion.

3. The composition of any one of the preceding claims, wherein the composition comprises from about 30% by weight to about 75% by weight of the activator based on the total weight of the composition.

4. The composition of any one of the preceding claims, wherein the composition comprises from about 1% by weight to about 20% by weight of the dispersant based on the total weight of the composition.

5. The composition of any one of the preceding claims, wherein the dispersant comprises a polymer, copolymer, or ionic compound of synthetic nature or from a naturally derived material/biopolymer; optionally wherein the polymer or copolymer comprises at least one functional group chosen from carboxyl, sulfate, phosphate, amine, ammonium, and/or silane; optionally wherein the dispersant comprises an acrylic polymer, an acrylic copolymer, a styrene polymer, a styrene copolymer, a vinyl polymer, or a vinyl copolymer.

6. The composition of any one of the preceding claims, wherein the composition comprises from about 10% by weight to about 40% by weight of the humectant based on the total weight of the composition.

7. The composition of any one of the preceding claims, wherein the humectant comprises an alcohol, optionally a polyol such as glycerol.

8. The composition of any one of the preceding claims, wherein the composition comprises from about 0.1% by weight to about 0.5% by weight of a biocide agent based on the total weight of the composition.

9. The composition of any one of the preceding claims, wherein the biocide agent comprises an isothiazolinone, optionally benzisothiazolinone and/or methyl-4-isothiazolin-3-one.

10. The composition of any one of the preceding claims, wherein the composition comprises from about 0.1% by weight to about 0.5% by weight of a de-foamer based on the total weight of the composition.

11. The composition of any one of the preceding claims, wherein the de-foamer comprises silicone, a surfactant capable of promoting foam burst, or a hyper-branched polymer.

12. The composition of any one of the preceding claims, wherein the composition comprises from about 0.1% by weight to about 3.0% by weight of a rheology modifier based on the total weight of the composition.

13. The composition of any one of the preceding claims, wherein the rheology modifier comprises a thixotropic agent or a thickener, optionally wherein the rheology agent comprises a clay such as an organo-clay or synthetic clay, a hydrogenated castor wax, a polyamide, a silica such as fumed silica or colloidal silica, a cellulosic material, or a hydrophobically-modified material such as a hydrophobically modified ethoxylated urethane, a hydrophobically-modified alkali-swellable emulsion, a hydrophobically-modified hydroxy ethyl cellulose), or a hydrophobically modified ethoxylated urethane alkali swellable emulsion.

14. The composition of any one of the preceding claims, wherein the composition has a Brookfield viscosity at 25° C. within a range of about 1000 cP to about 3 500 cP.

15. The composition of any one of the preceding claims, wherein the composition has a pH equal to or greater than 8.0.

16. The composition of any one of the preceding claims, wherein the composition is stable for at least one week at a temperature between 2° C. and 45° C., optionally wherein the viscosity of the composition at 25° C. varies less than 10% during the at least one week.

17. The composition of any one of the preceding claims, wherein the composition is a homogeneous mixture.

18. A method of making the composition of any one of the preceding claims, the method comprising:
combining the activator with the dispersant, the humectant, and the at least one additive to form a mixture, optionally wherein the mixture comprises a homogeneous paste; and
combining the mixture with the water and optionally one or more other additives.

19. The method of claim 18, wherein combining the activator with the dispersant, the humectant, and the at least one additive includes preparing a blend of the humectant, the dispersant, and the at least one additive, and then combining the blend with the anhydrous sodium sulfate and/or alkali biopolymer.

20. The method of claim 18 or 19, wherein the method includes:
preparing a blend by combining the humectant, the dispersant, and a biocide agent;
combining the blend with the activator to form a mixture;
combining the mixture with the water to form a slurry; and
adding a rheology modifier and/or one or more other additives to the slurry.

21. The method of claim 20, wherein the blend further comprises a de-foamer.

22. A cement mixture comprising, based on the total weight of the cement mixture:
at least 50% by weight of a combination of the composition of any one of claims 1 to 17 and a supplementary cementitious material; and
less than 50% by weight cement, such as General Purpose cement.

23. The cement mixture of claim 22, further comprising a Shrinkage Limited cement.

24. The cement mixture of claim 22 or 23, further comprising one or more cementitious materials chosen from slag, fly ash, silica fume, other SCMs selected from industrial waste or by-products of various industries and/or naturally derived materials of pozzolanic nature, or a combination thereof.

25. The cement mixture of any one of claims 22 to 24, wherein the cement mixture comprises 20% or less by weight of the General Purpose cement.

26. A concrete composition comprising:
the cement mixture of any one of claims 22 to 25; and
an aggregate, admixtures and water.

27. The concrete composition of claim 26, wherein the aggregate comprises a coarse aggregate such as granite, basalt, quartz, laterite, or limestone.

28. The concrete composition of claim 26 or 27, further comprising a fine aggregate such as sand.

29. The concrete composition of any one of claims 26 to 28, wherein the concrete has an air content less than or equal to 10% by volume.

30. The concrete composition of any one of claims 26 to 29, wherein the concrete has an initial setting time less than or equal to 4.5 hours, and/or a final setting time less than or equal to 6 hours.

31. The concrete composition of any one of claims 26 to 30, wherein the concrete has a compressive strength at 28 days greater than or equal to 20 MPa.

32. A composition comprising:
about 10% by weight to about 75% by weight anhydrous sodium sulfate based on the total weight of the composition;
about 1% by weight to about 20% by weight of a dispersant based on the total weight of the composition;
about 10% by weight to about 40% by weight of a humectant based on the total weight of the composition;
at least one additive chosen from a rheology modifier, a de-foamer, a biocide agent, a surface tension agent, a biopolymeric additive, or a combination thereof; and
water;
wherein the composition is in the form of a slurry, a dispersion, a suspension, or an emulsion.

33. A method of making a cement mixture, the method comprising combining General Purpose cement and a supplementary cementitious material with a composition comprising:
anhydrous sodium sulfate;
a dispersant;
a humectant;
at least one additive chosen from a rheology modifier, a de-foamer, a biocide agent, a surface tension agent, a biopolymeric additives or a combination thereof; and
water;
wherein the composition comprises about 10% by weight to about 80% by weight solids, based on the total weight of the composition, the composition being in the form of a slurry, a dispersion, a suspension, or an emulsion.

34. The method of claim 33, wherein the cement mixture comprises less than 50% by weight of the General Purpose cement, based on the total weight of the cement mixture.
